(19) United States
(12) Patent Application Publication
(10) Pub. No.: US 2010/0315607 A1
(43) Pub. Date: Dec. 16, 2010

(54) MINI PROJECTOR FOR CALENDAR DATA

(75) Inventor: EMIL MIHAYLOV, Toronto (CA)

Correspondence Address: EMIL MIHAYLOV, 1632 WOODBINE HEIGHTS BLVD, TORONTO, ON, M4B 3A5, CA

(73) Assignee: EMIL MIHAYLOV, TORONTO (CA)

(21) Appl. No.: 12/509,452

(22) Filed: Jul. 25, 2009

(30) Foreign Application Priority Data
Jun. 15, 2009 (CA) 2669291

(51) Int. Cl. G03B 29/00; G03B 23/00; G03B 21/11

(52) U.S. Cl. 353/26 R; 353/43; 353/25

(57) ABSTRACT

A MINI PROJECTOR FOR CALENDAR DATA is a pocket size integrated device, combining the ability to render monthly calendar images with the ability to project them on an external surface from an integrated standalone tool. The innovative idea is the combining of the above capabilities into one device comprising independent energy source (battery), embedded calendar rendering application, integrated image projection component (light source), adjustable focus lens and operating control buttons.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

It is common in planning or status tracking business meetings to deal with issues related to dates and activities occurring over periods of time. Often there is no projector available in the room, which limits the participants' ability to share a visualization of calendar periods.

Individual portable devices, such as cell phones or handheld organizers have calendar applications, but they cannot be easily shared with others in the room.

To go around the need for calendar visualization for the group, facilitators do calendar white-boarding, which is time consuming, unaesthetic, static (impossible to move back and forth through calendar periods). Sometimes there is no or insufficient writing space on boards or walls. Often there is simply no way at all to visualize a calendar in the meeting area.

The need for a quick and simple way to produce just-in-time an image of a calendar, viewable by a number a people is a constant occurrence in an office setting.

There is no known method or device to satisfy such need, which prompted this invention. Portable calendar rendering utilities do not have projection capability. Projectors, including portable ones, require an external computational device plugged into them in order to produce a shared view of a calendar.

This invention is an advancement the field of applied convergence of computational and projection technology for the purpose of time management productivity enhancement.

### BRIEF SUMMARY OF THE INVENTION

The invention relates to the field of data presentation through electronic devices. The typical calendar rendering devices do not have projection capabilities. Projectors do not have calendar rendering capabilities.

This invention combines calendar rendering capability with projection capability in a single integrated device.

The inventive idea is that a shared calendar view can be rendered and projected on the wall, or any flat, light reflecting surface, with the push of a button on a small integrated mini projector for calendar data.

The device may be either standalone or integrated in other utilities, such as a pen, key holder or even a mobile phone or handheld organizer.

The device can be operated while hand-held or placed on the table and the projection height controlled through a folding bracket attached to the body of the device.

### BRIEF DESCRIPTION OF THE DRAWINGS

FIG. 1/4—hand-held use of mini projector to display a single month calendar view on the wall

FIG. 2/4—hand-held use of mini projector to display multiple month calendar view on the wall

FIG. 3/4—hands-free use of mini projector, set on a table surface, with projection height controlled through changing the angle of the folding support bracket

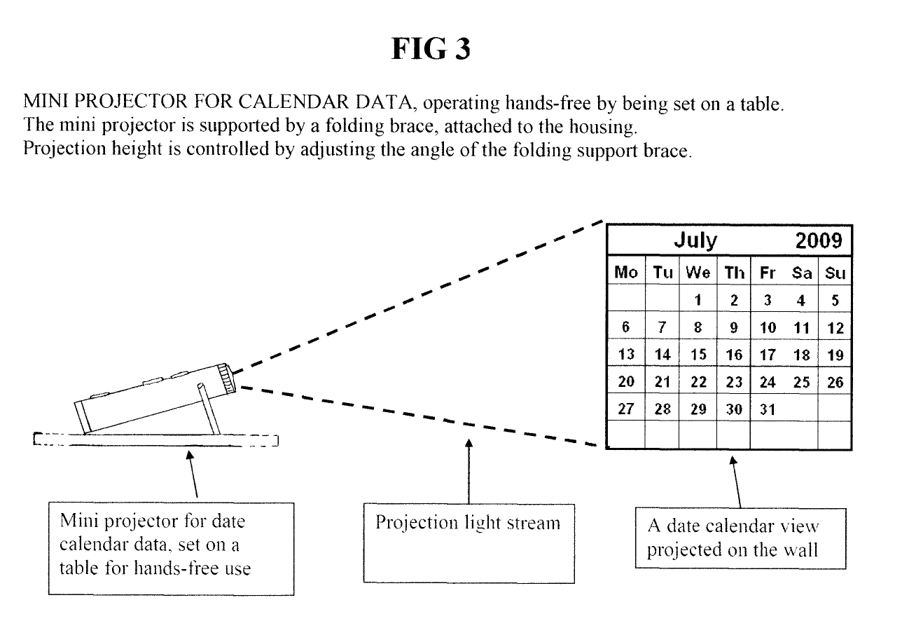

FIG. 4/4—top view, illustrating controls consistent with the functionality of a typical mini projector for calendar data

### DETAILED DESCRIPTION OF PREFERRED EMBODIMENT

The mini projector for calendar data generally comprises the following components:

Independent energy source—a replaceable or rechargeable battery

Embedded calendar rendering application

Projection component

Adjustable lens

Functional controls and switches

A housing with folding support bracket for hands-free use

The mini projector for calendar data has the following distinctive features:

Combining calendar rendering with projection capability

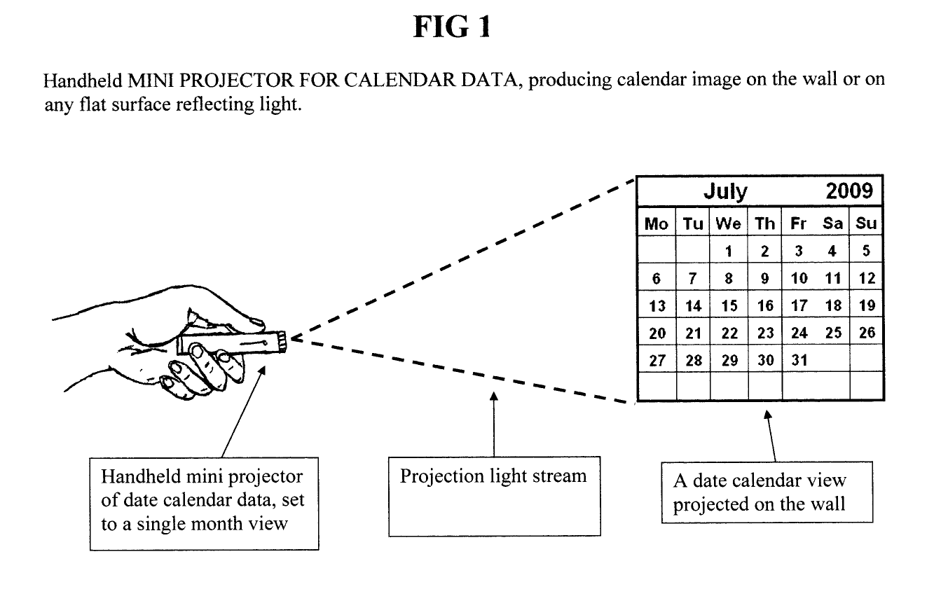

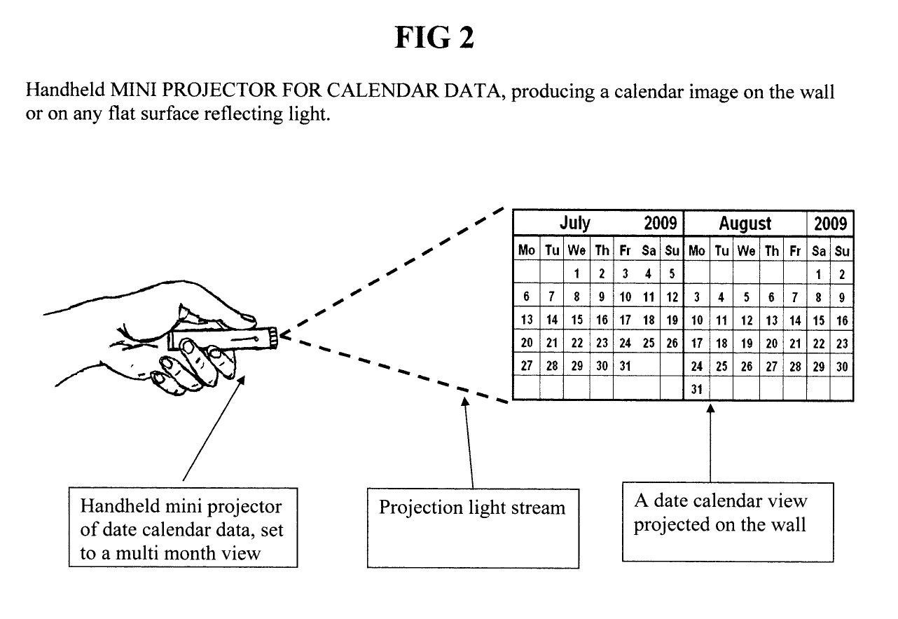

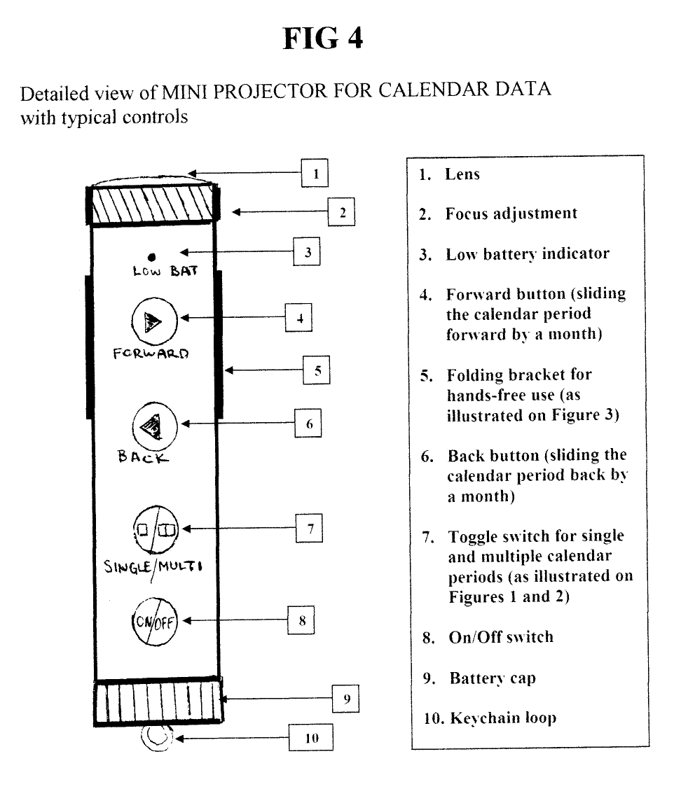

Toggle switching between one and multiple month periods in a single view. This is illustrated in FIG. 1/4 and FIG. 2/4. Switching is controlled with button 7, as illustrated on FIG. 4/4

Focus adjustment for varying distance between device and projection surface by turning clockwise or counterclockwise control 2 on FIG. 4/4

Sliding the calendar period forward and back by 1 month at a time with buttons 4 and 6, respectively (FIG. 4/4).

Independent energy source—a replaceable battery, which can be accessed by unscrewing battery cap 9 (FIG. 4/4)

Low battery indicator (feature 3 on FIG. 4/4), which in a typical application will stay on as an indication of normal battery level, but will start flashing to indicate low battery charge.

The device is pocket sized and can be attached to a keychain with the help of loop 10 (FIG. 4/4)

The embodiments of the invention in which an exclusive property or privilege is claimed are defined as follows:

1. A standalone device, combining calendar rendering with calendar image projection capability and comprising independent energy source, embedded calendar rendering component and controls, integrated image projection component, controls and adjustable focus lens.

2. A standalone device, as defined in claim 1, with toggle switching capability between single and multiple month views.

3. A standalone device, as defined in claim 1 and claim 2, with added freestanding capability via a folding support attached to the mini projector housing.

4. A standalone device, as defined in claim 1, claim 2 and claim 3, in which the calendar rendering component is a rolling microfilm in place of an embedded software application.

5. Integration of the device as defined in claim 1, claim 2, claim 3 and claim 4 as an extension to any other utility such as pen, mobile phone, handheld organizer, keypad, torchlight, watch, portable computer or desktop projector.
